(19) United States
(12) Patent Application Publication
(10) Pub. No.: US 2024/0267838 A1
(43) Pub. Date: Aug. 8, 2024

(54) SYSTEM AND METHOD TO PERFORM PUBLIC LAND MOBILE NETWORK (PLMN) SELECTION IN ROAMING SCENARIOS

(71) Applicant: Samsung Electronics Co., Ltd, Suwon-si (KR)

(72) Inventors: Koustav ROY, Bangalore (IN); Jagadeesh GANDIKOTA, Bangalore (IN); Lalith KUMAR, Bangalore (IN); Danish Ehsan HASHMI, Bangalore (IN); Anurag MANDILWAR, Bangalore (IN)

(21) Appl. No.: 18/426,998

(22) Filed: Jan. 30, 2024

Related U.S. Application Data
(63) Continuation of application No. PCT/KR24/01281, filed on Jan. 26, 2024.

(30) Foreign Application Priority Data
Feb. 2, 2023 (IN) 202341006864
Jan. 15, 2024 (IN) 202341006864

(51) Int. Cl. H04W 48/18; H04W 48/08; H04W 60/00; H04W 84/04

(52) U.S. Cl. CPC H04W 48/18; H04W 48/08; H04W 60/00; H04W 84/042

(57) ABSTRACT

The disclosure discloses a system and a method implemented in the UE to perform PLMN selection using a locally stored slice aware steering of roaming (SoR) list. According to an embodiment the UE prioritizes the PLMN based on the locally stored SoR list. The UE further maintains an updated enhanced slice aware SoR information list having an updated network slice support information along with granularity information per tracking area identity of each PLMN in a database of the UE. In an embodiment, the UE updates the SoR information list in its database based on a response that is received upon sending a registration request from the PLMN.

### CROSS-REFERENCE TO RELATED APPLICATIONS

This application is a continuation of International Application No. PCT/KR2024/001281 designating the United States, filed on Jan. 26, 2024, in the Korean Intellectual Property Receiving Office and claiming priority to Indian Provisional Patent Application No. 202341006864, filed on Feb. 2, 2023, and Indian Complete Patent Application No. 202341006864, filed on Jan. 15, 2024, in the Indian Patent Office, the disclosures of each of which are incorporated by reference herein in their entireties.

### BACKGROUND

### Field

The disclosure relates to a wireless communication system, and for example, to a system and method to perform public land mobile network (PLMN) selection in roaming cases using a locally stored slice aware steering of roaming (SoR) list.

### Description of Related Art

In mobile communication systems, both a subscriber and a mobile operator prefer conducting roaming activities with local operators boasting a high-quality network. The ability for a home network to choose a roaming network while a user equipment (UE) is engaged in roaming is referred to as a steering of roaming (SoR). Further, the home network configures a set of prioritized preferences for roaming networks, also referred to as an SoR list to intelligently guide the UE in the selection of the most suitable roaming network from the SoR list for seamless and optimal connectivity.

The SoR list is used to influence the subscriber's selection of a visited network when roaming. The SoR list may include a prioritized ordering of networks based on factors such as agreements between operators, quality of service (QOS), roaming tariffs, or other business considerations. The SoR list further includes slice information that the UE may support for availing particular services corresponding to a particular public land mobile network (PLMN).

Further, the home network operator configures and manages the SoR list, providing guidance to the subscriber's mobile device about the preferred networks to select when roaming in different locations. This helps to ensure that the subscriber may connect to specific networks that have been designated as preferred by their home operator, enhancing the overall roaming experience.

In Release 17, the 5G standalone mode standard has been aligned to service-based PLMN selection for the UE. To achieve the same, 3GPP came up with a new concept called enhanced slice aware SoR information provided by a home PLMN (HPLMN). The enhanced slice aware SoR information includes a list of preferred PLMNs for specific single network slice selection assistance information (S-NSSAIs) in the UE subscription. The list of preferred PLMNs may also be a single PLMN that is known by the HPLMN to support the S-NSSAI, or a list of PLMNs in preference order that differs from an order of generic SoR information. The enhanced slice aware SoR information further includes an operator PLMN (OPLMN) list. Along with the OPLMN list in the enhanced slice aware SoR information, the HPLMN may provide one more list where the HPLMN maps each slice to a list of PLMNs. The list of PLMNs holds information about which PLMN is designated as a priority PLMN for the specific S-NSSAI. As an example, consider the list of PLMNs as shown in Table 1. According to the list of PLMNs, as shown in Table 1, the UE considers PLMN-1 as a higher priority PLMN compared to PLMN-2 when the UE wants to use the S-NSSAI-1. Further, when the UE wants to use the S-NSSAI-2, the PLMN-2 has a higher priority than the PLMN-1. Thus, the information in the list of PLMNs assists the UE in choosing the PLMNs based on service or slice requirements.

TABLE 1

for S-NSSAI-1: PLMN-1/VPLMN-1, PLMN-2/VPLMN-2, and
for S-NSSAI-2: PLMN-2/VPLMN-2, PLMN-1/VPLMN-1.

The 3GPP Specification TR 23.700-41 provides concepts for Key Issue #2, “Support of providing Visited PLMN (VPLMN) network slice information to a roaming UE.” According to this a slice-based SoR mechanism to deliver the enhanced slice aware SoR information reuses the current SoR mechanism defined in TS 23.122 [7] for SoR information delivery.

Further, only the UE supporting slice-based SoR feature may receive the enhanced slice-aware SoR information via unified data management (UDM), the enhanced slice aware information includes preferred PLMNs for specific S-NSSAIs in the UE subscription. A preferred PLMN list may also be a single PLMN that is known by HPLMN to support the S-NSSAI, or a list of PLMNs in a preference order that differs from the order of the basic SoR information that is also provided. When more than one S-NSSAI has slice aware information and all these S-NSSAIs are needed by the UE, a weighted approach to preferred PLMN selection is used.

In the PLMN selection by the UE, even though the UE receives enhanced slice aware SoR information or visited PLMN (VPLMN) shares supported enhanced slice aware SoR information to the HPLMN for sending it to the UE, there is no guarantee that the UE always gets supported slices (S-NSSAIs) when the UE selects the VPLMN.

For example, consider a case as shown in Table 1, where the UE requires services for both S-NSSAI-1 and S-NSSAI-2 and S-NSSAI-1 has higher priority for the UE as compared to S-NSSAI-2. Thus, according to the weighted approach the UE will prioritize PLMN-1/VPLM-1 over PLMN-2/VPLM-2 as PLMN-1/VPLMN-1 has higher priority over PLMN-2/VPLMN-2 when S-NSSAI-1 is considered.

However, the underlying issue is that slice support across PLMN/VPLMN may not be homogenous as per 3GPP. The slice support may depend upon various factors such as the deployment of the slice in a tracking area (TA), RAN level QoS, slice support (RAN Slicing), etc. For example, in the case of rejected S-NSSAI, 3GPP has introduced the cause ‘Slice is not supported in this tracking area’ to inform the UE that specific rejected slices are not supported within the tracking area. Even inside the tracking area, the slice support may not be homogenous as per 3GPP. Further, to convey this non-homogeneous information 3GPP has brought further concepts of partially allowed and partially rejected slices. Furthermore, in another scenario, the slice support in the PLMNs/VPLMNs also depends upon the load on the slices in that network. For example, the network slice admission control function will monitor an allowed number of UEs or an allowed number of PDU sessions for a particular slice and when that allowed number of UEs or allowed number of PDU sessions is reached, a non-access stratum configuration function (NASCF) entity may reject the slice with cause depicting a maximum number of UEs or a maximum number of PDU session has been reached for that slice optionally with a back-off timer.

FIG. 1 is a signal flow diagram illustrating a scenario when the UE is performing the PLMN selection and the slice aware SoR information, according to a conventional technique. FIG. 1 shows that the UE 101 is in communication with the VPLMN-1 103 and HPLMN 105. Further, the UE 101 is roaming in a particular tracking area. Accordingly, at operation S101, the HPLMN 105 provides the enhanced slice aware SoR information to the UE 101 as shown in Table 2:

TABLE 2

S-NSSAI-1: VPLMN-1, VPLMN-2
S-NSSAI-2: VPLMN-1, VPLMN-2.

In the example scenario, it is to be considered that S-NSSAI-1 and S-NSSAI-2 are not supported in the given tracking area.

At operation S103, the UE 101 determines that the UE 101 needs services both for S-NSSAI-1 and S-NSSAI-2. At operation S105, the UE prioritizes VPLMN-1 over VPLMN-2, as VPLMN-1 has a higher priority than VPLMN-2 for both S-NSSAI-1 and S-NSSAI-2 as per the provided enhanced slice aware SoR information. At operation S107, the UE 101 sends a registration request to VPLMN-1 with requested S-NSSAI as S-NSSAI-1 and S-NSSAI-2. At operation S109, the VPLMN-1 sends ‘Registration Accept’ with both rejected S-NSSAI, as S-NSSAI-1 and S-NSSAI-2 are not supported in this tracking area. At operation S111, the UE 101 determines that the UE 101 may use neither the service of S-NSSAI-1 nor S-NSSAI-2 even though the UE prioritizes VPLMN-1 for both services. In this case, the UE 101 may get service if the UE 101 would have selected VPLMN-2.

FIG. 2 is a signal flow diagram illustrating a scenario when the UE is performing the PLMN selection and the slice aware SoR information is not supported by some VPLMN(s), according to a conventional technique. As depicted, at operation S201, the HPLMN 105 provides an operator PLMN (OPLMN) list and the enhanced slice aware SoR information to the UE 101 as below in Table 3.

TABLE 3

```
1. OPLMN list: VPLMN-2, VPLMN-1
2. Enhanced Slice Aware SoR information list:
    for S-NSSAI-1: VPLMN-1, and
    for S-NSSAI-2: VPLMN-1.
```

In the example scenario, it is to be considered that the VPLMN-2 does not support slice aware SoR information list. Hence, the slice aware SoR information list contains only VPLMN-1. At operation S203, the UE 101 determines that the UE 101 needs services both for S-NSSAI-1 and S-NSSAI-2. At operation S205, the UE 101 prioritizes VPLMN-1 over VPLMN-2, as VPLMN-1 has all required S-NSSAI support and VPLMN-2 does not have any slice support as per slice aware SoR information list. Further, at operation S207, the UE 101 sends a registration request to VPLMN-1 with requested S-NSSAI as S-NSSAI-1 and S-NSSAI-2. At operation S209, VPLMN-1 sends ‘Registration Accept’ with both rejected S-NSSAI as S-NSSAI-1 and S-NSSAI-2 are not supported in this tracking area. At operation S211, the UE 101 determines that the UE 101 may use neither the service of S-NSSAI-1 nor S-NSSAI-2 even though the UE prioritizes VPLMN-1 for both services.

FIG. 3 is a signal flow diagram illustrating a scenario when the UE is performing the PLMN selection and the HPLMN does not support the slice aware SoR information list, according to a conventional technique. As depicted in FIG. 3, at operation S301, HPLMN 105 provides an OPLMN list and configured slices per PLMN as shown in Table 4. In the example scenario, it is to be considered that the HPLMN 105 does not support the slice aware SoR information list.

TABLE 4
OPLMN list: VPLMN-1, VPLMN-2,
Configured S-NSSAI for VPLMN-1: S-NSSAI-1, and
Configured S-NSSAI for VPLMN-2: S-NSSAI-1, S-NSSAI-2

Further, at operation S303, the UE 101 determines that the UE 101 needs service for both S-NSSAI-1 and S-NSSAI-2. However, the UE 101 does not have the enhanced slice aware SoR information list as the HPLMN 105 does not support the slice aware SoR information list. Further, at operation S305, the UE 101 follows the OPLMN list and prioritizes VPLMN-1 103. Further, at operation S307, the UE 101 sends a registration request to VPLMN-1 103 with requested S-NSSAI as S-NSSAI-1 and S-NSSAI-2. At operation S309, VPLMN-1 sends ‘Registration Accept’ with S-NSSAI-1 in the allowed S-NSSAI list and S-NSSAI-2 as the rejected S-NSSAI list. At operation S311, the UE 101 determines that it may only use the service of S-NSSAI-1. However, if the UE 101 had selected VPLMN-2, then the UE 101 may utilize the service of both S-NSSAI-1 and S-NSSAI-2 as per the configured S-NSSAI list.

Therefore, from the above-discussed issues in FIGS. 1, 2 and 3, choosing/selecting a PLMN/VPLMN solely based on the enhanced slice aware SoR information list does not guarantee that those slices will be available or allowed in any tracking area, any global cell IDs of the PLMN, or even in the entire PLMN (e.g. in case of VPLMN) gives wrong information to Home Public Land Mobile Network (HPLMN) to monetize more. Thus, the slice support information provided by the network is very dynamic and a static list of enhanced SoR information list may not guarantee the slice availability in the entire PLMN. Thus, if the UE merely follows the enhanced slice-aware SoR information list, the primary objective of the slice or service-based PLMN selection is not satisfied.

Thus, there lies a need to provide a technique that may address each of the above-discussed problems.

### SUMMARY

According to an example embodiment of the disclosure, a method to perform public land mobile network (PLMN) selection in a user equipment (UE) is disclosed. According to an example embodiment, the method comprises: receiving, from a home PLMN (HPLMN) at least one enhanced slice aware steering of roaming (SoR) information list; identifying network slices supported by each PLMN among a plurality of PLMNs for at least one required service based on the enhanced slice aware SoR information list; and selecting a first PLMN for the at least one required service among the plurality of PLMNs based on the identified network slices and UE specific slice aware list stored in a database of the UE.

According to an example embodiment, a user equipment (UE) configured to perform public land mobile network (PLMN) selection is disclosed. The UE includes: at least one processor, comprising processing circuitry, individually and/or collectively, configured to: receive, from a home PLMN (HPLMN) at least one enhanced slice aware steering of roaming (SoR) information list; identify network slices supported by each PLMN among a plurality of PLMNs for at least one required service based on the enhanced slice aware SoR information list; and select a first PLMN for the at least one required service among the plurality of PLMNs based on the identified network slices and UE specific slice aware list stored in a database of the UE.

According to an example embodiment, one or more non-transitory computer-readable storage media storing computer-executable instructions that, when executed by at least one processor of a user equipment (UE), cause the UE to perform operations is disclosed. The operations comprises receiving, from a home PLMN (HPLMN) at least one enhanced slice aware steering of roaming (SoR) information list; identifying network slices supported by each PLMN among a plurality of PLMNs for at least one required service based on the enhanced slice aware SoR information list; and selecting a first PLMN for the at least one required service among the plurality of PLMNs based on the identified network slices and UE specific slice aware list stored in a database of the UE.

To further clarify the advantages and features of the disclosure, a more particular description of various example embodiments will reference to the appended drawings. It will be appreciated that these drawings merely depict example embodiments and are therefore not to be considered limiting its scope. The disclosure will be described and explained with additional specificity and detail with reference to the accompanying drawings in the detailed description below.

### BRIEF DESCRIPTION OF THE DRAWINGS

These and other features, aspects, and advantages of certain embodiments of the disclosure will be more apparent from the following detailed description, taken in conjunction with the accompanying drawings in which like characters represent like parts throughout the drawings, an in which:

FIG. 1 is a signal flow diagram illustrating a scenario when the UE is performing the PLMN selection and the slice aware SoR information, according to a conventional technique;

FIG. 2 is a signal flow diagram illustrating a scenario when the UE is performing the PLMN selection and the slice aware SoR information is not supported by some VPLMN(s), according to a conventional technique;

FIG. 3 is a signal flow diagram illustrating a scenario when the UE is performing the PLMN selection and the HPLMN does not support the slice aware SoR information list, according to a conventional technique;

FIG. 4 is a flowchart illustrating an example method for performing public land mobile network (PLMN) selection, according to various embodiments;

FIG. 5 is a signal flow diagram illustrating example operations for prioritizing PLMN based on the locally stored the slice aware SoR list, according to various embodiments;

FIG. 6 is a signal flow diagram illustrating example operations for updating and maintaining the slice aware SoR information list, according to various embodiments;

FIG. 7 is a signal flow diagram illustrating example operations for selecting PLMN based on the locally stored the slice aware SoR list when the VPLMN does not support slice aware SoR information list, according to various embodiments;

FIG. 8 is a signal flow diagram illustrating example operations for selecting PLMN based on the locally stored the slice aware SoR list when the HPLMN does not support Slice Aware SoR information list, according to various embodiments;

FIG. 9 is a flowchart illustrating an example method for high priority PLMN search, according to various embodiments;

FIG. 10 is a flowchart illustrating an example of higher priority PLMN search, according to various embodiments;

FIG. 11 is a block diagram illustrating an example configuration of a network, according to various embodiments; and

FIG. 12 is a block diagram illustrating an example configuration of a user equipment (UE) in a wireless network, according to various embodiments.

Further, skilled artisans will appreciate that elements in the drawings are illustrated for simplicity and may not have necessarily been drawn to scale. For example, the flowcharts illustrate the method in terms of steps involved to help to improve understanding of aspects of the disclosure. Furthermore, in terms of the construction of the device, one or more components of the device may have been represented in the drawings by conventional symbols, and the drawings may show those specific details that are pertinent to understanding the embodiments of the disclosure so as not to obscure the drawings with details that will be readily apparent to those of ordinary skill in the art having the benefit of the description herein.

### DETAILED DESCRIPTION

It should be understood at the outset that although various example embodiments of the disclosure are illustrated below, the disclosure may be implemented using any number of techniques, whether currently known or in existence. The disclosure should in no way be limited to the illustrative implementations, drawings, and techniques illustrated below, including the example design and implementation illustrated and described herein, but may be modified within the scope of the disclosure, including the appended claims and their full scope of equivalents.

The term “some” as used herein refer, for example, to “one, or more than one, or all.” Accordingly, the terms “one,” “more than one,” “more than one, but not all” or “all” would all fall under the definition of “some.” The term “some embodiments” may refer to one embodiment or to several embodiments or to all embodiments. Accordingly, the term “some embodiments” may refer, for example, to “one embodiment, or more than one embodiment, or all embodiments.”

The terminology and structure employed herein are for describing, teaching, and illuminating various example embodiments and their specific features and elements and do not limit, restrict, or reduce the spirit and scope of the claims or their equivalents.

For example, any terms used herein such as but not limited to “includes,” “comprises,” “has,” “have,” and grammatical variants thereof do NOT specify an exact limitation or restriction and certainly do NOT exclude the possible addition of one or more features or elements, unless otherwise stated, and must NOT be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features”, “one or more elements”, “at least one feature”, or “at least one element.” Furthermore, the use of the terms “one or more”, and “at least one” feature or element does not preclude there being none of that feature or element unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having ordinary skill in the art.

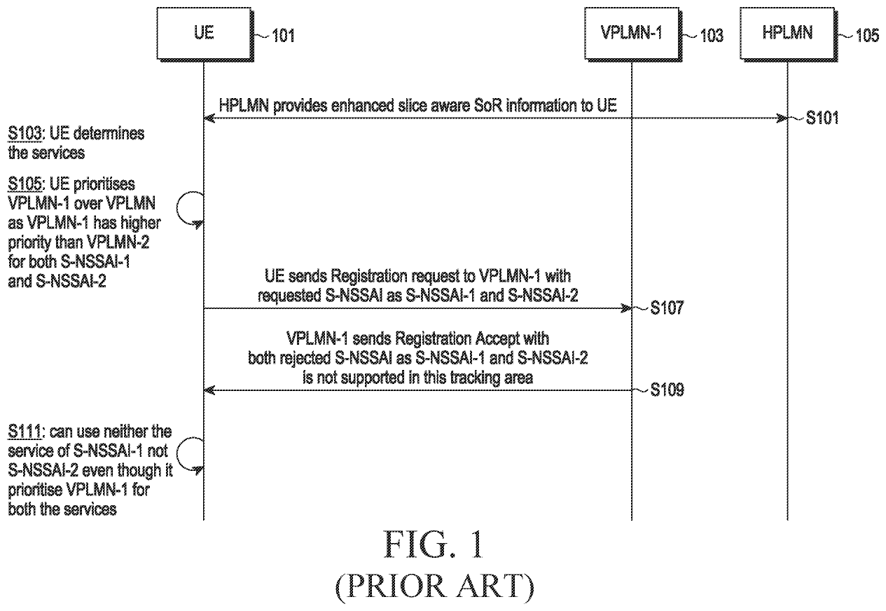

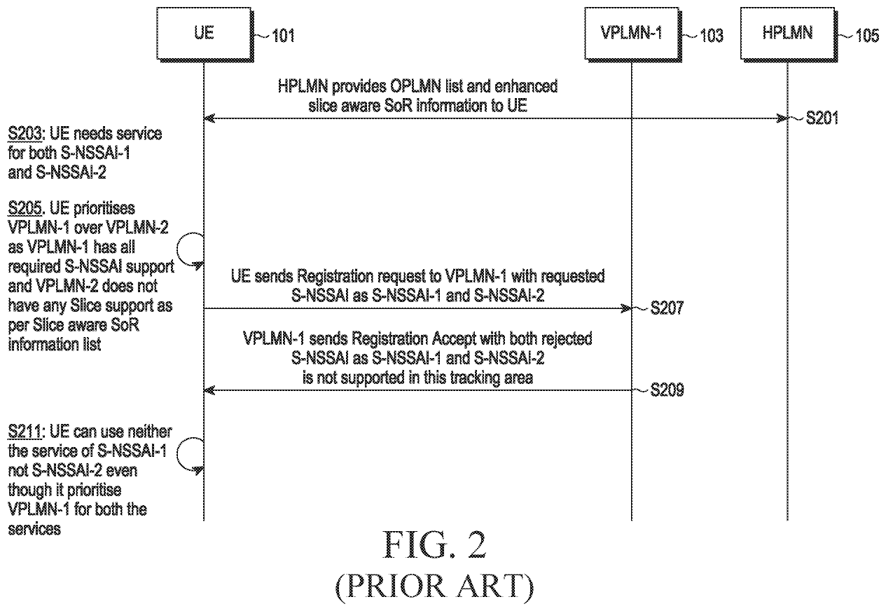

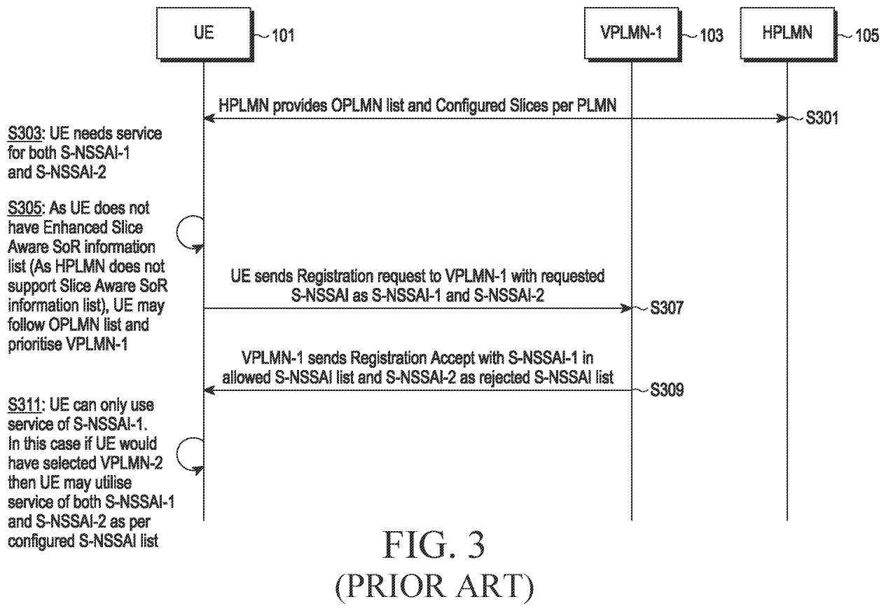

FIGS. 1 through 12, discussed below, and the various embodiments and descriptions of the principles of the disclosure are by way of illustration only and should not be construed in any way to limit the scope of the disclosure. Those skilled in the art will understand that the principles of the disclosure may be implemented in any suitably arranged system or device.

Throughout the disclosure, the expression “at least one of a, b, or c” indicates only a, only b, only c, both a and b, both a and c, both b and c, all of a, b, and c, or variations thereof.

Terms identifying access nodes, terms to refer to network entities or NFs, terms to refer to messages, terms to refer to interfaces between network entities, etc., are examples for convenience of explanation. Accordingly, the disclosure is not limited to the terms as herein used and may use different terms to refer to the items having the same meaning in a technological sense.

For the convenience of explanation, the disclosure will hereinafter use terms and definitions defined by the third generation partnership project (3GPP), long-term evolution (LTE), 5G, and 6G standards. The disclosure is not, however, limited to the terms and definitions, and may equally apply to any systems that conform to other standards.

The disclosure discloses a system and a method implemented in the UE to perform PLMN selection in roaming cases using a locally stored slice aware steering of roaming (SoR) list. According to an embodiment, the UE maintains an updated enhanced slice aware SoR information list having an updated network slice support information along with granularity information per tracking area identity of each PLMN in a database of the UE. In an embodiment, the UE updates the SoR information list in its database based on a response that is received upon sending a registration request from the PLMN. A more detailed explanation of performing PLMN selection in the roaming scenario will be explained in greater detail below with reference to various figures.

The network slice support for a specific PLMN is very dynamic and changes from one tracking area to another tracking area. Accordingly, the Global Cell ID also gets changed from one Global ID to another Global Cell ID in accordance with the changes in the tracking area. Thus, it is important for the UE to create its own Slice Aware PLMN list which not only has PLMN-wise slice support information but also contains information about the actual tracking area, and the Global Cell ID of each network slice support for each PLMNs. For example, if a tracking area-1 of PLMN-1 supports S-NSSAI-1 and a tracking area-2 of PLMN-1 does not support S-NSSAI-1, then the UE may only store the information about the tracking area-1 of PLMN-1 having support for S-NSSAI-1. Similarly, if a Global Cell ID-1 of the tracking area-1 of PLMN-1 supports S-NSSAI-1 (e.g. Slice 1) and Global Cell ID-2 of the tracking area-1 of PLMN-1 does not support S-NSSAI-1 then the UE may only stores Global Cell ID-1 of tracking area-1 of PLMN-1 having support of the Slice 1. This information will be helpful when the UE decides on PLMN and performs a higher-priority PLMN search based on required slices.

Below are some of the types of network slice and deployments as per Release18 Specification. The below list has been introduced by 3GPP after considering network slice deployment may vary from one tracking area to another tracking area inside a registration area. Even the network slice may not be homogeneously deployed in a single tracking area. Below are some of the network slice options introduced by 3GPP as a part of Rel 18 study.
Partially Allowed NSSAI: Indicating the S-NSSAIs values the UE could use in the Serving PLMN or SNPN in some of the TAs in the current Registration Area. Each S-NSSAI in the Partially Allowed NSSAI is associated with a list of TAs where the S-NSSAI is supported.
Network Slice Area of Service: Indicating the area where a UE may access and get service of a particular network slice as more than zero resources are allocated to the network slice in the NG-RAN cells.
S-NSSAI location availability information: The S-NSSAI location availability information sent to the UE includes, for each applicable S-NSSAI of the Configured NSSAI, Location information indicating the cells of TAs in the RA where the related S-NSSAI is available if the S-NSSAI is not available in all the cells of the TA.

Network support for the network slice is defined on a per-tracking area granularity. It may be beneficial to deploy some network slices such that the network slice has a limited geographical availability that does not match existing tracking area boundaries. The operator may in this case decide to change the topology of the tracking areas so that the operator matches the boundaries of the network slice, or the operator may configure resources for the network slices in the cells of TAs where the network slices are to be available, and in areas of the TAs where the network slice is defined to be not available the cells are configured with zero resources. The access and mobility management function (AMF) receives from an OAM the information on the availability of the network slice when the granularity is smaller than TA, e.g. if the network slice area of service (NS-AoS) includes TAs where the network slice is not available in some cells of the TA. In order to optimize the end-to-end behaviour, the AMF may, based on NS-AOS information received from the OAM, configure supporting UEs with S-NSSAI location availability information, and the 5G network may need to monitor the S-NSSAI usage and enforce the NS-AoS e.g. if the UE does not support the S-NSSAI location availability information.

The UE that receives S-NSSAI location availability information may apply the information as follows:
If the S-NSSAI is rejected in the RA or rejected partially in the RA or rejected with a cause code that allows attempting to register the S-NSSAI again, the UE may request the S-NSSAI only if the S-NSSAI location availability information indicates that the S-NSSAI is available at the cell where the UE is camping.
If the S-NSSAI is in the Partially Allowed NSSAI, the UE shall not activate the User Plane for any already established PDU Session with that S-NSSAI if the UE is in a cell within the RA but outside the Location information of the S-NSSAI.
If the S-NSSAI is in the Partially Allowed NSSAI, and the UE in CM-IDLE mode is moved to a cell outside the Location information of the S-NSSAI, and the UE has an established PDU Session with that S-NSSAI, the PDU Session is kept.

According to the disclosed techniques, during a higher priority PLMN search, the UE will only search for specific Global Cell ID, frequencies, and tracking area codes for each PLMN where the network slice support is present to make the higher priority PLMN based on the required services or slices more fruitful and usable.

Thereby avoiding the PLMNs, the tracking area, or the Global Cell IDs where those required slices will not be supported.

According to an embodiment, the UE stores a cell ID (e.g. Global Cell ID), tracking area ID, and frequency level granularity for each PLMNs where the S-NSSAIs will be supported as per previous encounters or crowd-sourced information. The UE further uses this information based on the UE's current location to find out which cell or frequency or which tracking area code of VPLMNs may support the UE intended slices in the current location. Based on this information the UE updates a current PLMN priority and performs PLMN or cell or tracking area (re-)selection based on the cell ID, tracking area ID, and the frequency level granularity. Accordingly, if the UE already has the knowledge of Cell ID, and the tracking area level information where the intended slice may be supported, the UE will always pick the best PLMN as per the slice or service need thereby avoiding the issues discussed in detail above with reference to FIGS. 1, 2 and 3.

According to various embodiments, the UE stores the slice aware PLMN list with all possible granularity information. In a non-limiting example, the granularity information includes the tracking area code, the Global Cell ID, the PLMN ID, a Closed Subscriber Group ID, a Service Area ID, and the like. Further, if the UE does not have any information stored, the UE starts with slice aware SoR information and keeps updating the list based on a configured S-NSSAI, an allowed S-NSSAI, a rejected S-NSSAI, a partially allowed S-NSSAI, and a partially rejected S-NSSAI list, a RAN Level support for slices (may be broadcasted or dedicated information) configured by the network.

According to an embodiment, the UE may also store temporary causes or reject causes to identify temporary or permanent slices' availability or unavailability. For example, if the network is providing a reject cause then that slice is not available in the entire tracking area. Thus, the current tracking area never supports the required slice for the UE. On the other hand, if the network rejects the slice or a PDU session for the slice with cause maximum number or the UE reached for that particular slice or a maximum number of PDU Sessions has been reached for a particular slice, then the UE may identify this as temporary unavailability of the slices and may retry the same after some time. Further, the UE may also store the frequency, band, or E-UTRA absolute radio frequency channel number (EARFCN) of the current cell. This will help in scanning the particular EARFCNs or frequency or band for which the slice can be supported.

Optionally to check the location or time window validity information, the UE may also save the information corresponding to a current subscription. Optionally the UE may delete the information when the subscription has been updated or HPLMN updates the slice aware SoR information list, or the OPLMN list, or both. Table 5 depicts an example of the UE specific slice aware list stored in the database of the UE. The UE specific slice aware list corresponds to the slice aware SoR information list.

TABLE 5

| Parameters | Attributes |
|---|---|
| Slice/S-NSSAI | Primary Key |
| PLMN | Secondary Key |
| Tracking Area Code | Secondary Key |
| Global Cell id | Secondary Key |
| CAG id | Secondary Key |
| Frequency/Band/EARFCN | Text |
| Allowed/Rejected | Boolean |
| Reject Cause | Text |
| Location(Latitude/Longitude) | Text |
| Valid for current subscription | Boolean |

According to an embodiment, the UE updates the slice aware list for the particular tracking area code, Global Cell ID along with a serving PLMN optionally with corresponding reject cause with a back-off timer wherever applicable for corresponding slice support when any of the configured NSSAI, the allowed NSSAI, the rejected NSSAI, the partly allowed, the NSSAI partly rejected NSSAI, the alternative NSSAI, the slice aware SoR information list or OPLMN list changes in the UE or the PDU session corresponds to the network slice has been rejected or released by the network.

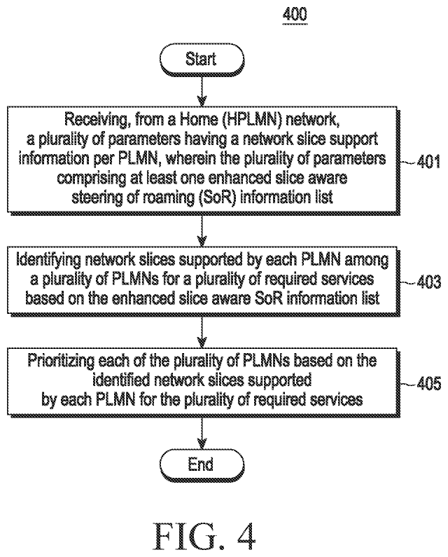

FIG. 4 is a flowchart illustrating an example method for performing PLMN selection, according to various embodiments. Method 400 illustrated in FIG. 4 illustrates an example method for performing PLMN selection in roaming scenario. According to an embodiment, it is considered that UE 101 is roaming and deployed with HPLMN.

According to an embodiment, initially, when the UE 101 is in roaming, the UE 101 at operation 401, receives a plurality of parameters having a network slice support information per PLMN. In an embodiment, the plurality of parameters comprising at least one enhanced SoR information list from the HPLMN 105. According to a further embodiment, the plurality of parameters associated with the plurality of PLMN further includes at least one of the configured S-NSSAI per PLMN, the allowed S-NSSAI per PLMN, the rejected S-NSSAI per PLMN, the partly allowed S-NSSAI per PLMN, the partly rejected S-NSSAI per PLMN, or the OPLMN list as explained in the above paragraphs. Further, the enhanced SoR information list comprises a list of S-NSSAIs supported by each PLMN as explained in the above paragraphs.

According to an example embodiment, consider that the HPLMN 105 provides enhanced slice aware SoR information to the UE 101 as shown in Table 6:

TABLE 6

S-NSSAI-1: VPLMN-1, VPLMN-2
S-NSSAI-2: VPLMN-1, VPLMN-2

Further, the UE 101 at operation 403, identifies network slices supported by each PLMN among a plurality of PLMNs for a plurality of required services based on the enhanced slice aware SoR information list. The plurality of required services are the services provided or identified by individual network slices. For example, S-NSSAI-1 may provide streaming services, S-NSSAI-2 may provide gaming services and the like. Now if PLMN 1 supports S-NSSAI-1 and PLMN-2 support S-NSSAI-2 as per slice aware SoR information list then it can be said that PLNM-1 supports streaming services and PLNM-2 supports gaming services. Likewise, for the example depicted in Table 6, consider that S-NSSAI-1 may provide IoT services and S-NSSAI-2 may provide enhanced mobile broadband (eMBB) Service. Now if VPLMN 1 supports S-NSSAI-1 and VPLMN-2 support S-NSSAI-2 as per slice aware SoR information list then it can be said that VPLNM-1 supports IoT services and PLNM-2 supports eMBB services.

According to an example embodiment, consider that the UE 101 determines that there is a need of services for S-NSSAI-1.

In an embodiment, the UE 101 checks the slice aware SoR information list stored in the database. Further, at operation 405, the UE 101 prioritizes each of the plurality of PLMNs based on the identified network slices supported by each PLMN for the plurality of required services. According to an example embodiment, the consider that after checking the slice aware SoR information list, the UE finds that VPLMN 2 supports support all required Slices from stored information. Thus, the UE 101 prioritizes the VPLMN-2 over VPLMN-1.

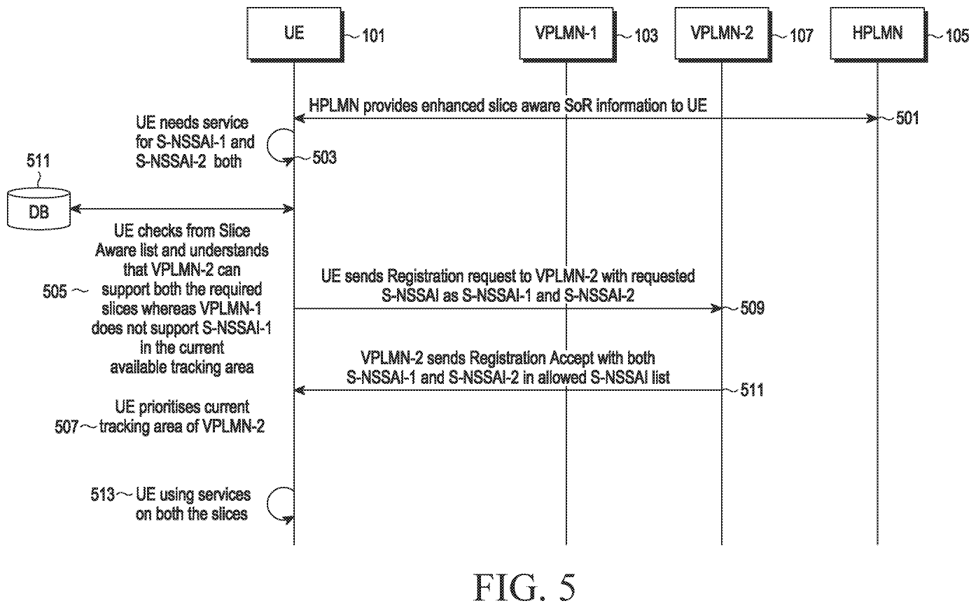

FIG. 5 is a signal flow diagram illustrating example operations for prioritizing PLMN based on the locally stored the slice aware SoR list, according to various embodiments. According to an embodiment example as shown in FIG. 5, at operation 501, during the roaming scenario, the HPLMN 105 provides the enhanced slice aware SoR information to the UE 101. Considering the same enhanced slice aware SoR information as depicted in Table 6. At operation 503, the UE 101 determines that there is a requirement of services for S-NSSAI-1 and S-NSSAI-2 both. At operation 505, the UE 101 checks the enhanced slice aware SoR information list and identifies network slices supported by each PLMN based on the enhanced slice aware SoR information list that is stored in the database of the UE 101. Accordingly, for the example shown in Table 6, the UE 101 determines that VPLMN-2 may support both the required slices whereas VPLMN-1 does not support S-NSSAI-1 in the currently available tracking area from the stored enhanced slice aware SoR list. For example, VPLMN 2 which is of lower priority supports both the required slices and the VPLMN 1 which is of higher priority does not support S-NSSAI-1. At operation 507, the UE 101 prioritizes the current tracking area of the VPLMN-2 based on the identified network slices supported by each PLMN for the plurality of required services.

At operation 507, the UE 101 selects a PLMN with a low priority PLMN than the PLMN having a higher priority among the plurality of PLMNs for providing the plurality of required services based on the updated enhanced SoR information list, the granularity information, and the reception of the response including a rejection of the registration request. Accordingly, the UE 101 prioritizes the VPLMN-2 for the current tracking area of VPLMN-2. At operation 509, the UE 101 sends a registration request to VPLMN-2 with requested S-NSSAI as S-NSSAI-1 and S-NSSAI-2. At operation 511, the VPLMN-2 sends Registration Accept with both S-NSSAI-1 and S-NSSAI-2 in the allowed S-NSSAI list. The UE 101 at operation 513, uses services on both the required slices. Accordingly, the UE 101 prioritizes PLMN based on the enhanced slice Aware SoR information list maintained/stored in the database 511. Further, in a case when required VPLMN/PLMN does not supported in the Slice Aware SoR information list, the UE 101 prioritizes the PLMN based on the enhanced slice Aware SoR information list maintained/stored in the database 511 and selects the PLMNs accordingly.

Updating and maintaining the slice aware SoR information list in the database of the UE is described in greater detail below.

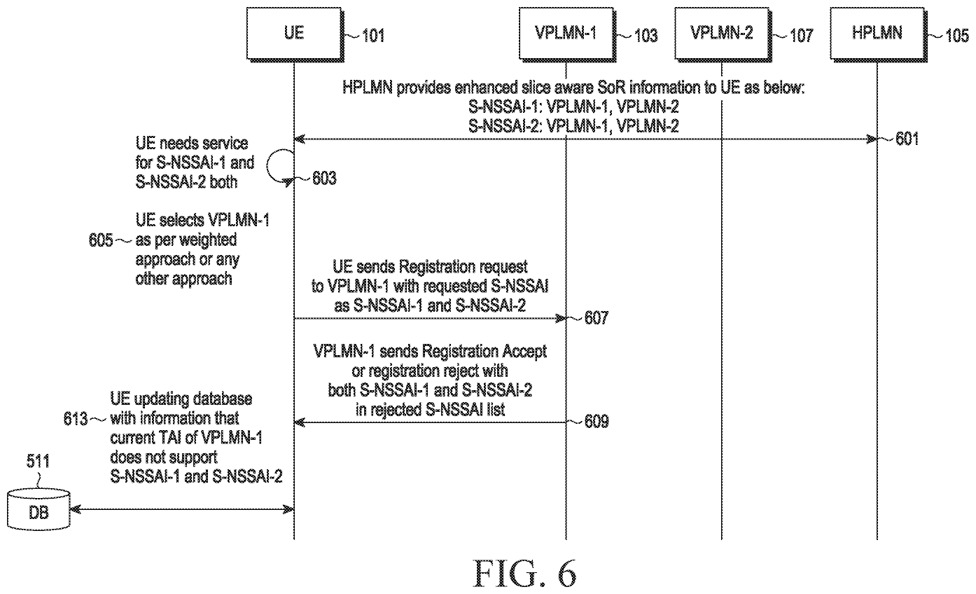

FIG. 6 is a signal flow diagram illustrating example operations for updating and maintaining the slice aware SoR information list, according to various embodiments. According to an embodiment, consider that UE is roaming and deployed with HPLMN 105. According to an embodiment, initially, when the UE 101 is in roaming, the UE 101 at operation 601, receives a plurality of parameters having a network slice support information per PLMN. Further, the UE 101 at operation 603, identifies network slices supported by each PLMN among a plurality of PLMNs for a plurality of required services based on the enhanced slice aware SoR information list. According to an example embodiment, consider that the UE 101 determines that there is a need of services for S-NSSAI-1 and S-NSSAI-2 both.

At operation 605, the UE 101 selects a first PLNM based on the provided enhanced slice aware SoR information, as per the weighted approach or any other approach. Further, the UE 101 sends the registration request to a first PLMN among the plurality of PLMNs based on the enhanced slice aware SoR information and a result of the identification. According to the example scenario consider that the UE 101 sends registration requests to the VPLMN-1 103 (e.g. first PLMN), at operation 607. Further, in response to the registration requests, the UE 101 receives, at operation 609, a response to the registration request from the first PLMN (e.g. VPLMN-1 103). In an embodiment, the response includes one of an acceptance or the rejection of the registration request for the corresponding S-NSSAI(s) and the corresponding S-NSSAI(s). According to the example scenario, the UE 101 may receive one of the ‘registration accept’ or “registration reject” with both S-NSSAI-1 and S-NSSAI-2 in the rejected S-NSSAI list. Accordingly, based on the received response of the registration request from the first PLMN, the UE 101 maintains the updated enhanced slice aware SoR information list having the updated network slice support information along with the granularity information per tracking arca identity of each PLMN in a database 511 of the UE 101.

According to the example embodiment, consider that VPLMN-1 103 does not support S-NSSAI-1 and S-NSSAI-2. Accordingly, the UE 101 receives a rejection cause corresponding to the S-NSSAI(s) when the response includes rejection of the registration request. Thus, the UE 101 receives the rejection cause for the VPLMN-1 as it does not support the requested S-NSSAI-1 and S-NSSAI-2. Upon receiving the rejection cause, the UE 101 determines the granularity information per tracking area ID for each PLMN. The UE 101 further determines one of a change or release in the plurality of parameters by the HPLMN 105 upon receiving the rejection cause. Based on the above determination related to the granularity information per tracking area ID for each PLMN, the change or the release in the plurality of parameters by the HPLMN and information about not supporting the requested S-NSSAIs are stored in the database 511 of the UE 101. Further, the enhanced slice aware SoR information list is updated. According to the example scenario, at operation 613, the UE 101 updates the database 511 with information that the current tracking area ID (TAI) of VPLMN-1 does not support S-NSSAI-1 and S-NSSAI-2. Thus, the updated enhanced slice aware SoR information list comprises a list of updated S-NSSAIs supported by each PLMN.

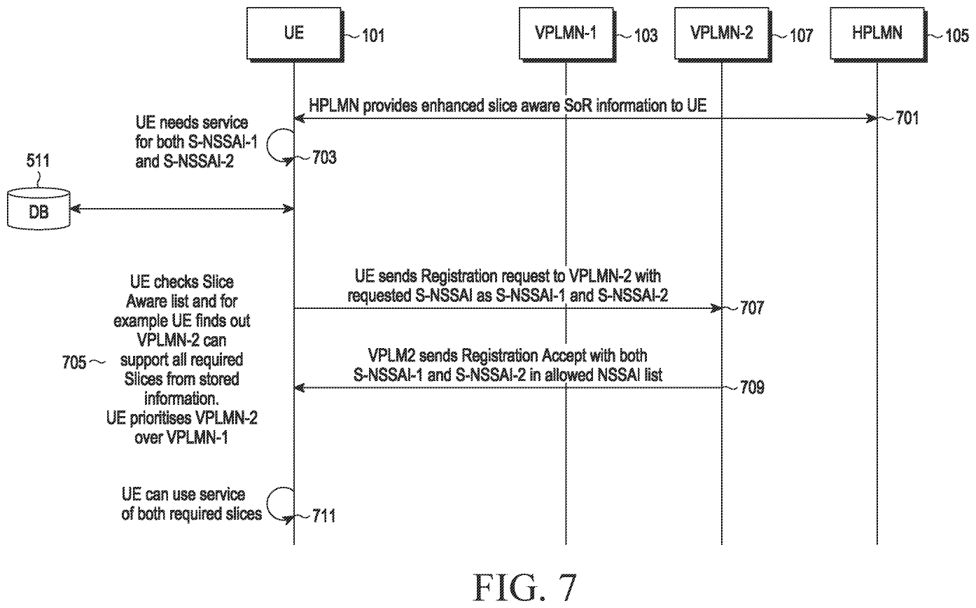

FIG. 7 is a signal flow diagram illustrating example operations for selecting PLMN based on the locally stored the slice aware SoR list when the VPLMN does not support Slice Aware SoR information list, according to various embodiments. FIG. 7 illustrates an operation flow when the VPLMN does not support the slice aware SoR information list. According to an embodiment, at operation 701, the HPLMN 105 provides the OPLMN list and the enhanced slice aware SoR information list as shown in Table 7.

TABLE 7

OPLMN list: VPLMN-2, VPLMN-1
Enhanced Slice Aware SoR information list:
S-NSSAI-1: VPLMN-1
S-NSSAI-2:

In the example scenario, it is to be considered that VPLMN-2 does not support slice aware SoR information list. Hence Slice Aware SoR information list only contains VPLMN-1 103.

At operation 703, the UE 101 determines a requirement of the service for both S-NSSAI-1 and S-NSSAI-2. Thereafter, at 705, the UE 101 checks the Slice Aware SoR list and identifies that the VPLMN-2 107 may support all required slices from the stored Slice Aware SoR list and information. Accordingly, the UE 101, at operation 705, the UE 101 prioritizes VPLMN-2 107 over VPLMN-1 103. At operation 707, the UE 101 sends the registration request to VPLMN-2 107 with the requested S-NSSAI as S-NSSAI-1 and S-NSSAI-2. Further, the VPLMN-2 107 sends ‘registration accept’ with S-NSSAI-1 and S-NSSAI-2 as allowed NSSAI list at operation 709. Thus, at operation 711, the UE may use the services of both required slices.

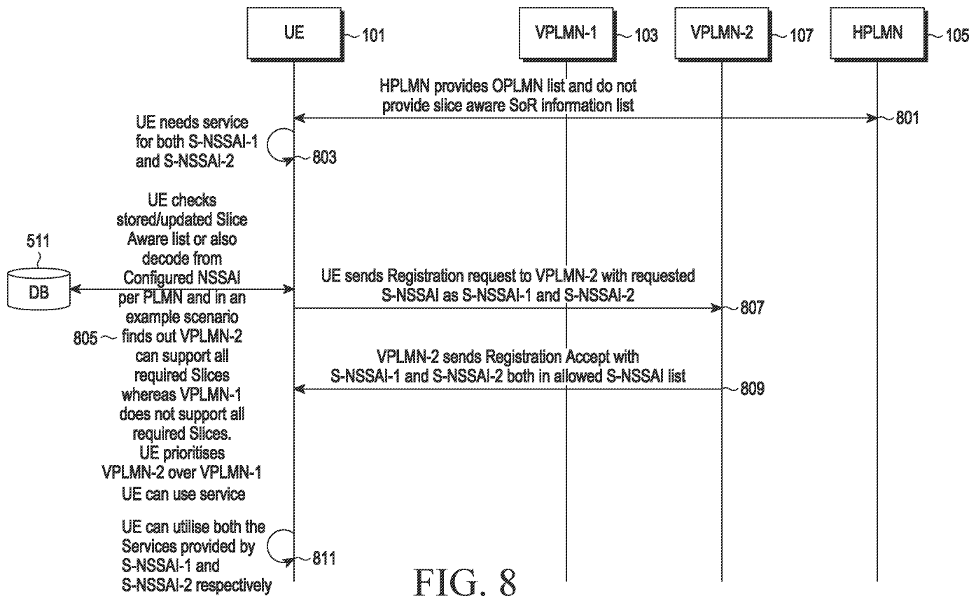

FIG. 8 is a signal flow diagram illustrating example operations for selecting PLMN based on the locally stored the slice aware SoR list when the HPLMN does not support Slice Aware SoR information list, according to various embodiments. FIG. 8 illustrates an operation flow when the HPLMN does not support the slice aware SoR information list. According to an embodiment, at operation 801, the HPLMN 105 provides the OPLMN as shown in Table 8.

TABLE 8

OPLMN list: VPLMN-1, VPLMN-2
Configured S-NSSAI for VPLMN-1: S-NSSAI-1
Configured S-NSSAI for VPLMN-2: S-NSSAI-1, S-NSSAI-2

At operation 801, the HPLMN 105 provides the OPLMN list and does not provide the slice aware SoR information list as it has an earlier release version or support of slice aware SoR information is not present. At operation 803, the UE 101 determines whether there is a requirement for service for both S-NSSAI-1 and S-NSSAI-2. At operation 805, the UE 101 checks stored/updated Slice Aware list or also decode from Configured NSSAI per PLMN whether the requirement for service for both S-NSSAI-1 and S-NSSAI-2 can be supported by the PLMNs provided in the OPLMN list. In an example scenario, the UE 101 identifies that VPLMN-2 107 may support all required slices whereas VPLMN-1 103 does not support all required Slices. Accordingly, the UE 101 prioritizes VPLMN-2 107 over VPLMN-1 103. The UE 101 sends the registration request to VPLMN-2 107 with the requested S-NSSAI as S-NSSAI-1 and S-NSSAI-2 at operation 807. At operation 809, the VPLMN-2 sends ‘Registration Accept’ with S-NSSAI-1 and S-NSSAI-2 both in the allowed S-NSSAI list. Accordingly, the UE 101, at operation 811, may utilize both the services provided by S-NSSAI-1 and S-NSSAI-2 respectively.

According to an embodiment, the UE triggers a higher priority PLMN search whenever the UE slice requirement gets changed. In an embodiment, when the UEs slice requirement has been changed, the UE has to check from the enhanced slice aware SoR information list and reformulate PLMN priority possibly on the lowest granularity (e.g. cell ID, TAC ID, CSG as already described above) based on current slice requirements. The enhanced slice aware SoR information list can be obtained from the locally stored database or from the network. If UE finds serving PLMN or cell ID or TAC ID is not the highest priority PLMN granularity, then the UE may choose to perform PLMN search or PLMN (re-) selection as per the decided granularity level. According to various embodiment, the UE may also wait for a predefined or newly defined time e.g. Higher Priority PLMN search timer or any other timer or until UE goes to CMM-IDLE mode before triggering the higher priority PLMN search. According to one or more embodiments, the UE may also lower the current serving PLMN priority based on slice restriction e.g. intended slice has been put to the rejected NSSAI list for the current registration area on the current serving PLMN, and hence the UE chooses to trigger the higher priority PLMN search. Further, if a corresponding PDU session establishment for a required slice has been rejected by the network or the corresponding PDU session for a required slice has been released by the network abruptly (e.g. the network slice admission control function check) the UE may choose to perform lowering serving PLMN priority for the intended slices and also perform PLMN search or the PLMN selection as per the already decided priority list. In an embodiment, the higher priority PLMN search optimization will also hold true for any existing higher-priority PLMN search triggered by the UE. In an embodiment, during the higher priority PLMN search the UE prepares the list of higher priority PLMNs with the granularity information. According to various embodiments, the UE may also precompute this higher priority PLMN list with granularity information before the higher priority PLMN (HP-PLMN) search is triggered. The granular information helps the UE to restrict the search or control the search only for the required granularity for each PLMN in an orderly manner.

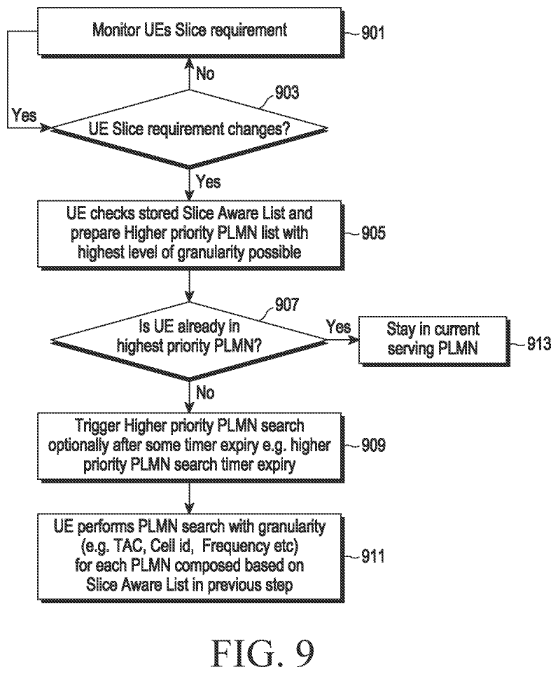

FIG. 9 is a illustrating an example method for high priority PLMN search, according to various embodiments. According to an embodiment, at operation 901, the UE monitors a change in the UE slice requirement for the plurality of required services. At operation 903, the UE determines whether the UE slice requirement changes. If the change in the UE slice requirement for the plurality of required services is determined by the UE based on the result of monitoring (Yes at 903), then at operation 905, the UE checks whether the updated S-NSSAIs in the updated enhanced slice aware SoR information list are capable to fulfill the UE slice requirement. For example, the UE checks the stored Slice Aware List and prepares a higher priority PLMN list with the highest level of granularity. At operation 907, the UE determines whether the UE is currently served by the highest priority PLMN based on network information. As an example, the network provides information about the currently serving PLMNs. Thus, the UE more particularly checks whether the UE is already in the highest priority PLMN. Further, if it is determined that the UE is already served by the highest priority PLMN (Yes at operation 907), then at operation 913, the UE stays in the current serving PLMN. Further, if it is determined that the UE is not served by the highest priority PLMN (No at operation 907), then at operation 909, the UE triggers the higher priority PLMN search upon expiry of a predefined time period. At operation 911, the UE performs PLMN search with the granularity information for each PLMN based on the slice aware SoR list in the previous operation. Thereafter, the UE selects the highest priority PLMN for providing the plurality of required services based on the result of the higher priority PLMN search and the granularity information.

For example, if UE is currently camped on VPLMN-2 and UE finds VPLMN-1 may support current network slice requirements only over tracking area code 1 and tracking area code 2, then the UE may only search for tracking area code 1 and tracking area code 2 of VPLMN-1 and consider that specific tracking area codes only as a higher priority and ignore all other tracking areas available in that area for VPLMN-1 as required slices may not be supported in other tracking areas as per slice aware list.

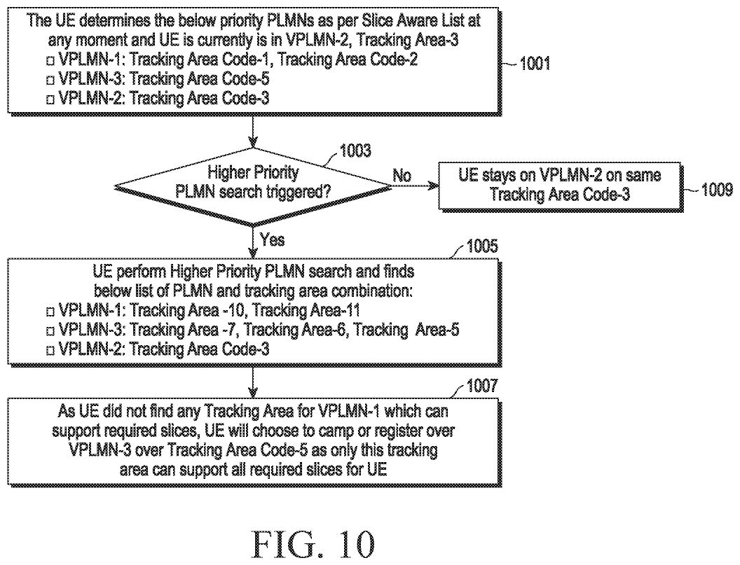

FIG. 10 is a flowchart illustrating an example method of higher priority PLMN search, according to various embodiments. In an example scenario, at operation 1001, consider that the UE determines below (Table 9) higher priority PLMNs as per the slice aware list at any moment and the UE is currently in VPLMN-2, tracking area-3.

TABLE 9

VPLMN-1: Tracking Area Code-1, Tracking Area Code-2
VPLMN-3: Tracking Area Code-5
VPLMN-2: Tracking Area Code-3.

In this above condition, if a higher priority PLMN search has been triggered either due to existing triggers of higher priority PLMN search or due to slice requirement changes in the UE, as UE is in the tracking area-3 of VPLMN-2, the UE may perform higher priority PLMN search as shown in operation 1003.

In this condition as an example scenario, consider that the UE finds below (Table 10) the list of PLMN and tracking area combinations at operation 1005.

TABLE 10
VPLMN-1: Tracking Area-10, Tracking Area 11
VPLMN-3: Tracking Area-7, Tracking Area-6, Tracking Area-5
VPLMN-2: Tracking Area Code-3.

As the UE did not find any tracking area for VPLMN-1 which may support required slices, the UE may choose to camp or register over VPLMN-3 over tracking area code-5 as only this tracking area may support all required slices for the UE at operation 1007. Further, at operation 1003, if the higher priority PLNM search is not triggered (No at operation 1003), then at operation 1009, the UE stays on VPLMN-2 on the same tracking area code-3.

In various embodiments, the UE may follow the OPLMN list priority to decide the highest priority PLMN if no available PLMNs may support the UE required slices or services.

In various embodiments, the slice aware list may refer to a data store either locally or crowdsourced, which stores the information of cell ID, tracking area ID, CAG ID, and the service area level slice support for each PLMN.

In various embodiments, the UE may use the slice aware list along with any other information such as slice aware SoR information list, OPLMN list, configured NSSAI (slice) per PLMN, allowed NSSAI (slice) for a tracking area in a PLMN, rejected NSSAI (slice) per PLMN, alternative NSSAI (slice), partly allowed NSSAI (slice), partly rejected NSSAI (slice) in a tracking area for a PLMN and any other pre-configured or dynamically configured list to decide the PLMN priority based on service or slice availability. In an embodiment, the UE follows the PLMN priority during any kind of PLMN search, for example, the higher priority PLMN search, and this priority list of PLMN keeps on changing based on service or slice requirement in the UE and optionally with location and time (due to location and time window criteria in URSP rule) the UE decides the priority.

In various embodiments, the method advantageously addresses the actual intention of 3GPP to prioritize PLMN based on services or slice support. The UE always prioritizes and selects the correct cell ID, tracking area code or any other granularity combination for a particular PLMN to avail all or most of the UE required services or slices. In one or more embodiments, the method advantageously makes sure that the UE will always be on the best possible PLMN, tracking area, or cell ID based on slice requirement or demand by utilizing the locally stored slice aware SoR list and granular information.

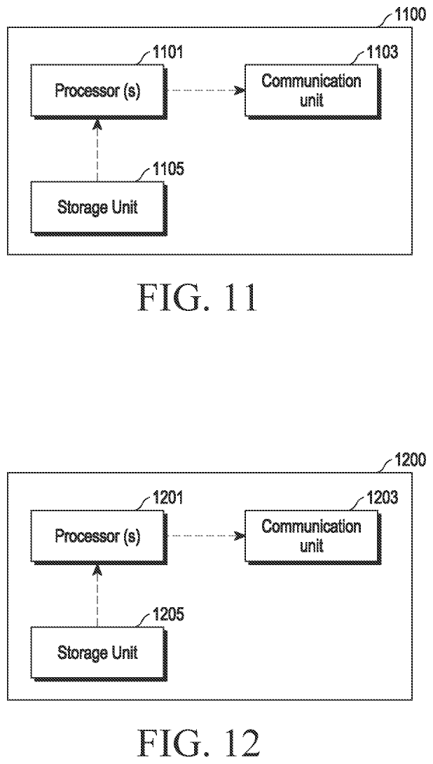

FIG. 11 is a block diagram illustrating an example configuration of a network, according to various embodiments. The network 1100 may correspond to 3GPP PLMN, VPLMN, and HPLMN as discussed throughout this disclosure. The network 1100 may include at least one processor (e.g., including processing circuitry) 1101, a storage unit (e.g., including a memory) 1105 (e.g., storage), and a communication unit (e.g., including communication circuitry) 1103 (e.g., communicator or communication interface). Further, the network 1100 may also include the cloud-RAN (C-RAN), a central unit (CU), a core network (NW), a distributed unit (DU), or any other possible network (NW) entity. The communication unit 1103 may perform one or more functions for transmitting and receiving signals via a wireless channel.

As an example, the processor 1101 may be a single processing unit including various processing circuitry or a number of units including processing circuitry, all of which could include multiple computing units. The processor 1101 may be implemented as one or more microprocessors, microcomputers, microcontrollers, digital signal processors, central processing units, state machines, logic circuitries, and/or any devices that manipulate signals based on operational instructions. Among other capabilities, the processor 1101 is configured to fetch and execute computer-readable instructions and data stored in the memory. The processor 1101 may include one or a plurality of processors. At this time, one or a plurality of processors 1101 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 1102 may control the processing of the input data in accordance with a predefined operating rule or artificial intelligence (AI) model stored in the non-volatile memory and the volatile memory, e.g., memory unit 1101. The predefined operating rule or artificial intelligence model is provided through training or learning. The processor 1101 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The storage unit 1105 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

According to various embodiments, the block diagram as illustrated in FIG. 11 may be referred to for any network functions or network entities and the like.

FIG. 12 is a block diagram illustrating an example configuration of user equipment (UE) in a wireless network, according to various embodiments. The configuration of FIG. 12 may be understood as a part of the configuration of the UE 1200. Hereinafter, it is understood that terms including “unit” or “module” at the end may refer to the unit for processing at least one function or operation and may be implemented in hardware, software, or a combination of hardware and software.

Referring to FIG. 12, the UE 1200 may include at least one processor (e.g., including processing circuitry) 1201, a communication unit (e.g., including communication circuitry) 1203 (e.g., communicator or communication interface), and a storage unit (e.g., including a memory) 1205 (e.g., storage). By way of example, the UE 1200 may be the User Equipment 101, such as a cellular phone or other device that communicates over a plurality of cellular networks (such as a 3G, 4G, a 5G or pre-5G, 6G network or any future wireless communication network). The communication unit 1203 may perform functions for transmitting and receiving signals via a wireless channel.

As an example, the processor 1201 may include various processing circuitry including, for example, a single processing unit or a number of units, all of which could include multiple computing units. The processor 1201 may be implemented as one or more microprocessors, microcomputers, microcontrollers, digital signal processors, central processing units, state machines, logic circuitries, and/or any devices that manipulate signals based on operational instructions. Among other capabilities, the processor 1201 is configured to fetch and execute computer-readable instructions and data stored in the memory. The processor 1201 may include one or a plurality of processors. At this time, one or a plurality of processors 1201 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 1201 may control the processing of the input data in accordance with a predefined operating rule or artificial intelligence (AI) model stored in the non-volatile memory and the volatile memory, e.g., memory unit 1205. The predefined operating rule or artificial intelligence model is provided through training or learning. The processor 1201 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The storage unit 1205 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In a firmware or software configuration, the method and the communication according to various embodiments of the disclosure may be implemented in the form of modules, procedures, functions, etc. performing the above-described functions or operations. Instructions may be stored in a memory unit and executed by a processor. The memory unit may be located at the interior or exterior of the processor and may transmit and receive data to and from the processor via various known means.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Those skilled in the art will appreciate that the operations described herein in the disclosure may be carried out in other specific ways than those set forth herein without departing from essential characteristics of the disclosure. The above-described embodiments are therefore to be construed in all aspects as illustrative and not restrictive. The scope of the disclosure, including the the appended claims, should not be limited by the above description, and all changes coming fall within the scope of the disclosure, including the appended claims an their equivalents.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the disclosure or not, such as differences in structure, dimension, and use of material, are possible. The scope of embodiments is at least as broad as given by the following claims. It will also be understood that any of the embodiment(s) described herein may be used in connection with any other embodiment(s) described herein.

What is claimed is:

1. A method for performing public land mobile network (PLMN) selection in a user equipment (UE), the method comprising:
receiving, from a home PLMN (HPLMN), at least one enhanced slice aware steering of roaming (SoR) information list;
identifying network slices supported by each PLMN among a plurality of PLMNs for at least one required service based on the enhanced slice aware SoR information list; and
selecting a first PLMN for the at least one required service among the plurality of PLMNs based on the identified network slices and UE specific slice aware list stored in a database of the UE.

2. The method as claimed in claim 1, further comprising:
sending a registration request to the first PLMN among the plurality of PLMNs; and
maintaining, in the database of the UE, an updated enhanced slice aware SoR information list having an updated network slice support information list together with granularity information per tracking area identity of each PLMN based on a reception of a response of the registration request from the first PLMN.

3. The method as claimed in claim 2, further comprising:
selecting, based on the first PLMN not supporting the at least one required service, a second PLMN with a lower priority PLMN than the first PLMN among the plurality of PLMNs for providing the at least one required service based on the updated enhanced SoR information list, the granularity information, and the reception of the response including a rejection of the registration request.

4. The method as claimed in claim 3, wherein
the at least one enhanced slice aware SoR information list includes at least one of configured single-network slice selection assistance information (S-NSSAI) per PLMN, allowed S-NSSAI per PLMN, rejected S-NSSAI per PLMN, partly allowed S-NSSAI per PLMN, partly rejected S-NSSAI per PLMN, or operator PLMN (OPLMN) list, and
the updated enhanced slice aware SoR information list comprises a list of updated S-NSSAIs supported by each PLMN.

5. The method as claimed in claim 2, wherein the granularity information includes at least one of: a tracking area code, a global cell identification (ID), a PLMN ID, a closed subscriber group ID, or a service area ID.

6. The method as claimed in claim 3, wherein the response includes one of an acceptance or the rejection of the registration request and corresponding S-NSSAI(s),
wherein maintaining, in the database of the UE, the updated enhanced slice aware SoR information list having the updated network slice support information together with the granularity information per tracking area identity of each PLMN, comprises:
receiving a rejection cause corresponding to the S-NSSAI(s) based on the reception of the response including the rejection of the registration request;
determining, based on receiving the rejection cause, the granularity information per tracking area identity for each PLMN;
determining one of a change or release in the enhanced slice aware SoR information list by the HPLMN upon receiving the rejection cause; and
maintaining, in the database of the UE, the updated enhanced slice aware SoR information list having the updated network slice support information together with the granularity information per tracking area identity of each PLMN based on the determination of the change or release in the enhanced slice aware SoR information list.

7. The method as claimed in claim 3, wherein selecting the second PLMN having the lower priority PLMN than the first PLMN among the plurality of PLMN for providing the at least one required service, comprises:
identifying network slices supported by each PLMN among the plurality of PLMNs for the at least one required service based on the updated enhanced slice aware SoR information list; and
selecting, based on the first PLMN not supporting the at least one required service, the second PLMN having the lower priority than the first PLMN for providing the at least one required service based on the updated enhanced slice aware SoR information list.

8. The method as claimed in claim 7, further comprising:
monitoring a change in a UE slice requirement for the at least one required service;
determining whether the updated S-NSSAIs in the updated enhanced slice aware SoR information list is capable of fulfilling the UE slice requirement based on the change in the UE slice requirement for the at least one required service;
determining whether the UE is currently served by a highest priority PLMN based on the determination;
triggering a higher priority PLMN search upon expiry of a specified time period; and
selecting the highest priority PLMN for providing the at least one required service based on a result of the higher priority PLMN search and the granularity information.

9. A user equipment (UE) configured to perform public land mobile network (PLMN) selection, the UE comprising:
at least one memory storing instructions; and
at least one processor configured to execute the stored instructions to:
receive, from a home PLMN (HPLMN), at least one enhanced slice aware steering of roaming (SoR) information list;
identify network slices supported by each PLMN among a plurality of PLMNs for at least one required service based on the enhanced slice aware SoR information list; and
select a first PLMN for the at least one required service among the plurality of PLMNs based on the identified network slices and UE specific slice aware list stored in a database of the UE.

10. The UE as claimed in claim 9, wherein at least one processor, individually and/or collectively, is configured to execute the stored instructions to:
send a registration request to the first PLMN among the plurality of PLMNs; and
maintain, in the database of the UE, the enhanced slice aware SoR information list having an updated network slice support information list together with granularity information per tracking area identity of each PLMN based on the reception of the response of the registration request from the first PLMN.

11. The UE as claimed in claim 10, wherein at least one processor, individually and/or collectively, is configured to execute the stored instructions to:
select, based on the first PLMN not supporting the at least one required service, a second PLMN with a lower priority PLMN than the first PLMN among the plurality of PLMNs for providing the at least one required service based on the updated enhanced SoR information list, the granularity information, and the reception of the response including a rejection of the registration request.

12. The UE as claimed in claim 11, wherein
the at least one enhanced slice aware SoR information list further includes at least one of configured single-network slice selection assistance information (S-NSSAI) per PLMN, allowed S-NSSAI per PLMN, rejected S-NSSAI per PLMN, partly allowed S-NSSAI per PLMN, partly rejected S-NSSAI per PLMN, or operator PLMN (OPLMN) list, and
the updated enhanced slice aware SoR information list comprises a list of updated S-NSSAIs supported by each PLMN.

13. The UE as claimed in claim 10, wherein the granularity information includes at least one of a tracking area code, a global cell identification (ID), a PLMN ID, a closed subscriber group ID, or a service area ID.

14. The UE as claimed in claim 11, wherein the response includes one of an acceptance or the rejection of the registration request and corresponding S-NSSAI(s),
wherein to maintain, in the database of the UE, the updated enhanced slice aware SoR information list having the updated network slice support information together with the granularity information per tracking area identity of each PLMN, at least one processor, individually and/or collectively, is configured to:
receive a rejection cause corresponding to the S-NSSAI(s) based on the reception of the response including the rejection of the registration request;
determine, upon receiving the rejection cause, the granularity information per tracking area identity for each PLMN;
determine one of a change or release in the enhanced slice aware SoR information list by the HPLMN based on receiving the rejection cause; and
maintain, in the database of the UE, the enhanced slice aware SoR information list having the updated network slice support information together with the granularity information per tracking area identity of each PLMN based on the determination of the change or release in the enhanced slice aware SoR information list.

15. The UE as claimed in claim 11, wherein to select the second PLMN having the lower priority PLMN rather than the first PLMN among the plurality of PLMN for providing the at least one required service, at least one processor, individually and/or collectively, is configured to execute the stored instructions to:
identify network slices supported by each PLMN among the plurality of PLMNs for the at least one required service based on the updated enhanced slice aware SoR information list; and
select, based on the first PLMN not supporting the at least one required service, the second PLMN having the lower priority than the first PLMN for providing the at least one required service based on the updated enhanced slice aware SoR information list.

16. The UE as claimed in claim 15, wherein at least one processor, individually and/or collectively, is configured to execute the stored instructions to:
monitor a change in a UE slice requirement for the at least one required service;
determine whether the updated S-NSSAIs in the updated enhanced slice aware SoR information list is capable of fulfilling the UE slice requirement based on the change in the UE slice requirement for the at least one required service;
determine whether the UE is currently served by a highest priority PLMN based on the determination;
trigger a higher priority PLMN search upon expiry of a specified time period; and
select the highest priority PLMN for providing the at least one required service based on a result of the higher priority PLMN search and the granularity information.

17. One or more non-transitory computer-readable storage media storing computer-executable instructions that, when executed by at least one processor of a user equipment (UE), cause the UE to perform operations, the operations comprising:
receiving, from a home PLMN (HPLMN), at least one enhanced slice aware steering of roaming (SoR) information list;
identifying network slices supported by each PLMN among a plurality of PLMNs for at least one required service based on the enhanced slice aware SoR information list; and
selecting a first PLMN for the at least one required service among the plurality of PLMNs based on the identified network slices and UE specific slice aware list stored in a database of the UE.
